(19) United States
(12) Patent Application Publication
(10) Pub. No.: US 2005/0281653 A1
(43) Pub. Date: Dec. 22, 2005

(54) Automated trash delivery system

(76) Inventor: Donald Channel, Eustis, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/140,112

(22) Filed: May 27, 2005

Related U.S. Application Data
(60) Provisional application No. 60/574,839, filed on May 27, 2004.

(51) Int. Cl. B60P 1/64

(52) U.S. Cl. 414/498

(57) ABSTRACT

An autonomous trash delivery system including a guide wire, having a first end and a second end, buried beneath a ground covering, a power source connected to the first end of the wire providing power to the wire so that the wire emits an electromagnetic field, and a delivery vehicle, for transporting at least one of a trashcan receptacle and a recycling bin receptacle from a first location to a second location, having a first sensor system for detecting the electromagnetic field emitted from the guide wire, a drive motor for propelling the delivery vehicle, a power source for supplying power to the delivery vehicle, holding locations for holding at least one of a trashcan receptacle and a recycling bin receptacle on the delivery vehicle, a processor for controlling operation of the vehicle, a user input device to access the processor, a second sensor system for determining when at least one of the trashcan receptacle or the recycling bin receptacle has been removed from the delivery vehicle to empty its contents and then returned to the delivery vehicle, and a plurality of wheels to transport the delivery vehicle over a plurality of terrain surfaces.

This application claims priority of Provisional Patent Application Ser. No. 60/574,839,filed on May 27, 2004.

### BACKGROUND OF THE INVENTION

This invention relates to a trash delivery system and, more specifically, to an autonomous trash delivery system that is capable of delivering trash from a trash collection location to a location for subsequent trash removal regardless of the terrain between the collection location and the removal location.

Though several trash delivery systems are currently known in the art, many either require a surface mounted track system or a plurality of buried guide wires to assist a delivery vehicle with moving from a starting location to a second location. Once one of the prior art trash delivery systems has reached the trash removal location, typically curbside, a timer is utilized to determine when the delivery system should return to a starting location. In such situations, the delivery system may return too early if a trash collection service is late to pick up trash on a particular day. Also, if the timer is set to insure that the delivery system remains curbside for an extended period, the delivery system remains outside, in the elements, for an extended period, which could result in increased wear and tear on the system due to such elements as sun, heat, rain, and/or snow.

Many benefits would be realized with a trash delivery system that is autonomous and that does not require an above-ground track system or a plurality of buried guide wires. Further benefits are realized where the movement of the delivery system is not completely determined by a pre-programmed system.

### BRIEF DESCRIPTION OF THE INVENTION

Towards this end, the present invention discloses an autonomous trash delivery system and method. An autonomous trash delivery system has a guide wire, having a first end and a second end, buried beneath a ground covering, a power source connected to the first end of the wire providing power to the wire so that the wire emits an electromagnetic field, and a delivery vehicle for transporting at least one of a trashcan receptacle and a recycling bin receptacle from a first location to a second location. The delivery vehicle has a first sensor system for detecting the electromagnetic field emitted from the guide wire, a drive motor for propelling the delivery vehicle, and a power source for supplying power to the delivery vehicle. A holding locations for holding at least one of a trashcan receptacle and a recycling bin receptacle on the delivery vehicle is also part of the delivery vehicle. The delivery vehicle also has a processor for controlling operation of the vehicle, a user input device to access the processor, a second sensor system for determining when the trashcan receptacle and/or the recycling bin receptacle has been removed from the delivery vehicle to empty its contents and then returned to the delivery vehicle. The delivery vehicle also has a plurality of wheels to transport the delivery vehicle over a plurality of terrain surfaces.

In another embodiment, an automated trash delivery system comprises a signal generator for generating a signal wherein a plurality of frequencies are possible for the signal, a wire connected to the signal generator for carrying the signal from a first location to a second location, and a delivery vehicle, for transporting a trashcan receptacle and/or a recycling bin receptacle from the first location to the second location. The delivery vehicle comprises a first sensor system for detecting the signal carried by the guide wire, a drive motor for propelling the delivery vehicle, a power source, and a frame for securing a trashcan receptacle and/or a recycling bin receptacle. The delivery vehicle also has a processor for controlling operation of the delivery vehicle, a second sensor system for determining when at least the trashcan receptacle and/or the recycling bin receptacle has been removed from the delivery vehicle to empty its contents and then returned to the delivery vehicle. A plurality of wheels to transport the delivery vehicle over a plurality of terrain surfaces is also part of the delivery vehicle.

In another preferred embodiment a method for autonomously delivering trash receptacles from a first location to a second location for trash removal is disclosed. The method comprises activating a buried guide wire to emit a signal. Upon detecting the signal emitted from the guide wire, a step is provided for commanding a delivery vehicle holding trash receptacles to follow the emitted signal. Upon reaching a first end location of the buried wire emitting the signal, a step of commanding the delivery vehicle to stop is included. The method also includes detecting when the trash receptacles have been removed from the delivery vehicle and returned to the delivery vehicle, and commanding the delivery vehicle to follow the emitted signal. Upon reaching a second end location of the buried wire emitting the signal, the method includes the step of commanding the delivery vehicle to stop.

### BRIEF DESCRIPTION OF THE DRAWINGS

The figures shown depict only exemplary configurations that may be employed for the present invention. Those skilled in the art will recognize variations to the figures presented herein. The features and advantages of the present invention will become apparent from the following detailed description of the invention when read with the accompanying drawings in which:

FIG. 1 is an exemplary embodiment of an autonomous trash delivery system;

FIG. 2 is an exemplary embodiment of the autonomous trash delivery system, including guide wire and drive sensors.

FIG. 3 is an exemplary embodiment of an autonomous trash delivery system taking trash to a curb;

FIG. 4 is an exemplary embodiment of an autonomous trash delivery system returning to a garage;

FIG. 5 is an exemplary embodiment of a plurality of paths the autonomous trash delivery system may take to reach curbside.

### DETAILED DESCRIPTION OF THE INVENTION

With reference to the figures, exemplary embodiments of the invention will now be described. The scope of the invention disclosed is applicable to a plurality of uses, such as but not limited to a handicap chair to allow a user to check mail that is left at a curbside mailbox. Thus, even though embodiments are described specifically to a trash delivery system, the present invention is applicable to other uses or applications such as, but not limited to, other delivery systems for such items as a handicapped user to mail.

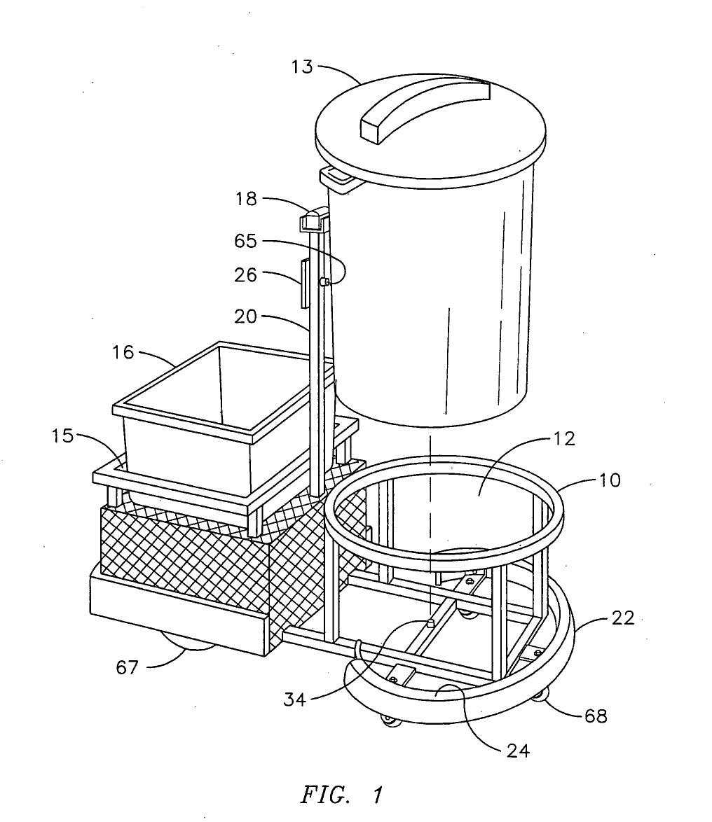

As illustrated in FIG. 1, the autonomous trash delivery vehicle 10 has a receiving area 12 to hold a trashcan 13 as well as a receiving area 15 to hold a recycling bin 16. In other preferred embodiments, not illustrated, a plurality of trashcan-receiving areas 12, as well a plurality of recyclable bin-receiving areas 15 may be part of the autonomous trash delivery vehicle 10.

Several safety features are part of the delivery vehicle 10. A strobe light 18 is part of the autonomous trash delivery vehicle 10. Though illustrated as being placed on a pole 20 above the rest of the delivery vehicle 10, those skilled in the art will readily recognize that the strobe light 18, or a plurality of strobe lights can be positioned on the delivery vehicle 10. Whenever the vehicle 10 is in motion, the strobe light 18 is illuminating, thus providing a visual warning that the vehicle 10 is in motion. Bumpers 22, preferably made of rubber, are placed around the front end of the vehicle 10. A sensor system 24 is built into the bumpers 22 to either sound an alarm when the vehicle 10 makes contact with a foreign object and/or sends a signal to a drive motor 30 which is responsible for propelling the delivery vehicle 10, causing the drive motor 30 to cease propelling the vehicle 10 forward when contact is detected.

In a preferred embodiment, a battery 32 powers the delivery vehicle 10. In an exemplary embodiment (not shown), the delivery vehicle 10 is recharged with a cable that connects to an electrical outlet whenever the vehicle is stationary at its trash collection location. Those skilled in the art will realize that an electrical connector can be provided on the delivery vehicle wherein when the delivery vehicle returns to its trash collection location, the electrical connector is positioned on the delivery vehicle so that it connects with an electrical receiver as the delivery vehicle comes to rest. In another preferred embodiment, a solar charging panel 26 is provided to charge the battery 32. In this embodiment the solar panel 26 is charging the battery 32 while the delivery vehicle 10 is awaiting trash removal, such as along a curbside 40.

When the delivery vehicle 10 reaches curbside 40, in one embodiment, only a timer dictates how long the delivery vehicle 10 remains curbside 40. In another exemplary embodiment, as further illustrated in FIG. 1, a sensor 34 is positioned beneath where a trashcan 13 would rest on the delivery vehicle 10. In one exemplary embodiment, once the trashcan 13 is removed, a timer 41 (which may be integrated within a processor 42) initiates, wherein the delivery vehicle 10 will return to its starting location 50 once a designated time period has expired, such as five minutes. In another exemplary embodiment, the sensor 34 is a pressure activated switching device. In this embodiment, the processor 42 counts the number of times the trash receptacles 13, 16 are removed and returned to determine when it is time to return the delivery vehicle 10 to its first location 50. The sensor 34 detects when the trashcan 13 is removed and then placed back upon the sensor 34. After a specific time period, such as one minute, the delivery vehicle 10 will then return to its starting position 50.

In another preferred embodiment, the sensor 34 is a scale, or weight-measuring device. The processor 42 is operable to record when the weight upon the sensor 34 is heaviest and when the vehicle 10 is located curbside 40. When the processor 42 records that the weight upon the scale is lighter, the vehicle 10 will return to the start location 50. In another preferred embodiment, a base weight is determined for the trashcan prior to any trash, or debris, being put into the trashcan 13. Thus once the trashcan 13 is emptied at curbside 40, the processor will read the weight reported by the sensor 34, being informed that the weight is less than the weight of the trashcan during transport and is exactly or close to the weight of the trashcan prior to any trash being put into the it.

The same techniques may also be utilized with the recycle-bin, or recycling bin receptacle 16. As discussed above the return of the vehicle to the start location 50 may occur after reading the return of the empty trashcan or a given time period after the return of the empty trashcan upon the sensor 34, if time is needed to recharge the battery. Another exemplary example of the sensor 34 is a visual image-detecting sensor that visibly knows when the trash receptacles 13, 16 are removed and then returned to the delivery vehicle 10. Another sensor technology that can be used is radio frequency identification devices (RFID) wherein RFID devices are connected to each trash receptacle 13, 16 and the delivery vehicle wherein once the RF connection is broken and then reconnected, the processor can then command the delivery vehicle 10 to return to its first location 50. Those skilled in the art will recognize that a plurality of different techniques utilizing the sensor 34 that evaluates weight or switches to count when the trashcan is or is not in place on the vehicle 10.

The processor 42 utilizes a firmware program to control the operation of the vehicle 10. As discussed above, a timer or system clock 41 is part of, or connected to the processor 42. An input/output receptacle is also connected to the processor 42 to allow for firmware updates to be loaded. Though a single processor board is illustrated, those skilled in the art will recognize that a plurality of processors or boards may be used. For example, a separate processor board 42 may be used to receive signals from the guide wire 52. This board may be power a second battery or another power source such as AC power.

A similar sensor 34 is also located beneath the recycle bin 16. The sensor 34 can be an electronic sensor that detects when the trashcan is in place or not, or a switch. If a switch, the switch can be configured to count and thus toggle between functions. For example, when a trashcan is first removed, the switch will count this as the trashcan being removed while curbside 40. If the next time the switch is activated is when the trashcan is returned to the delivery vehicle, the switch will count this change as having the trashcan back and will wait a predetermined period prior to returning to a starting position 50.

Depending on trash pickup schedules, the recycle bin sensor 34 and the trashcan sensor 34 may or may not work together. For example, if recycle collection days are different than trash collection days, the delivery vehicle 10 is programmed to recognize a particular sensor 34 on the specific day. However, when the recycle collection days and trash collection days are the same, typically different sanitation vehicles come curbside to collect the debris. In these situations, the sensors 34 operate together.

For example, since the sanitation vehicles are likely to collect respective debris at different times, the sensors 34 are linked, such as through a processor 42, to determine once both the trashcan 13 and the recycle bin 16 have been removed and returned to their respective sensors 34. Only after both have been removed and return to their respective resting positions will the delivery vehicle 10 return to its trash collection location 50. Those skilled in the art will recognize other scenarios in which the delivery vehicle 10 will wait until both receptacles have been emptied.

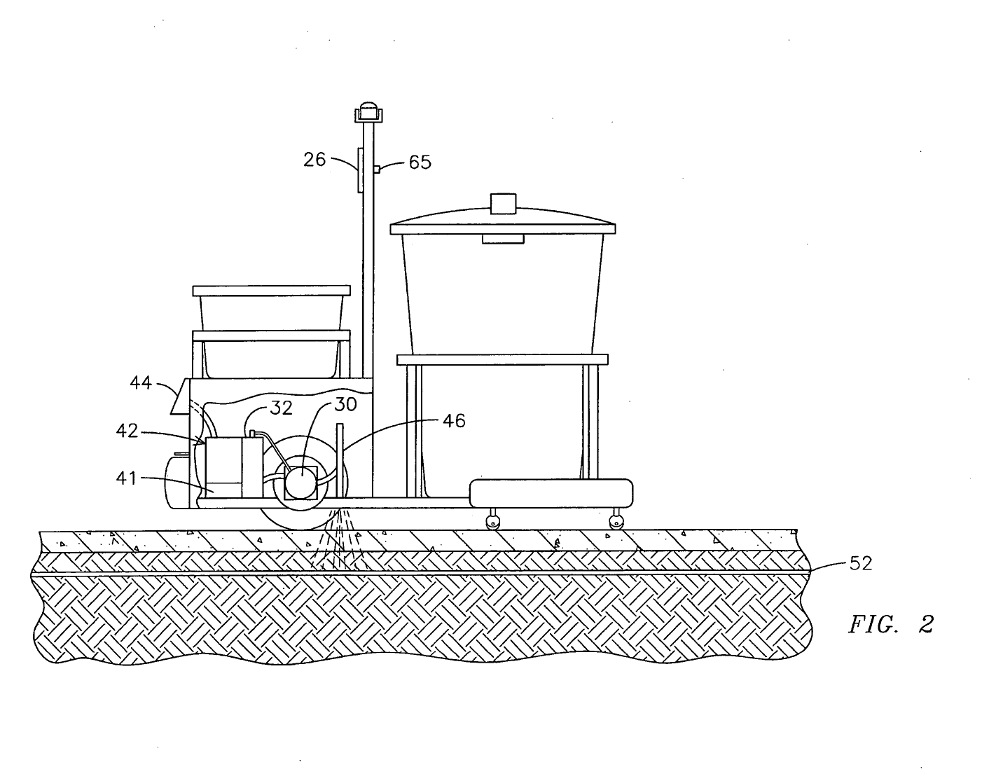

FIG. 2 is a side view of the present invention further illustrating the elements that are located within the delivery vehicle 10. As further illustrated, a microprocessor 42 is provided to control the operation of the delivery vehicle 10. As illustrated in FIG. 2 and FIG. 3, a program keypad 44 is available for a user to program operations for the delivery vehicle 10. The keypad 44 can include a LCD display so a user can easily determine the functions being set. For example, the user can program the days of the week which the vehicle 10 should transport debris to a curbside location 40. The user can also use the keypad 44 to designate how long the vehicle 10 should remain outside in view of the sun in order to recharge its battery 32. The keypad 44 will access the processor, or microprocessor 42 or control board. The microprocessor 42 will contain all of the operation parameters for the vehicle 10 including at least a contact, or guide, sensor 46 that is used to guide the vehicle 10 over an imbedded guide wire 52 that emits a low-level electromagnetic field signal. In one embodiment, each system will operate on its own unique frequency so that a neighboring property with the present invention will not interfere with the operation of the first system.

As further illustrated in FIG. 2, a wire 52 is disposed beneath the ground. Sensors 46 are provided on the vehicle 10 to detect the location of the wire 52 which, in turn, guide and direct the vehicle 10 along its intended path and to its intended location. In a preferred embodiment at least two sensors are provided on opposite sides of the vehicle 10 wherein the vehicle moves to keep the guide wire 52 between the two sensors 46. The sensors 46 are AC magnetic field sensors that are able to detect magnetic fields. In one embodiment, the sensors 46 are operatable to determine when the delivery vehicle 10 has already traversed the electric field emitted from the ground wire so that the vehicle does not return prematurely from its second location, or curbside 40. In another preferred embodiment, the processor commands the vehicle 10 to remain until trash removal is confirmed upon detecting that the vehicle has reached the end of the wire 52, such as detecting the ground rod 54 discussed below. In another preferred embodiment, at least four sensors 46 are aboard the delivery vehicle wherein two are forward sensing devices and two others are backward sensing devices. In this configuration, the backward sensing devices do not control the vehicle 10 until after trash removal has occurred.

In a preferred embodiment, the wire is 12 gauge. The wire 52 carries an AC current and emits a low level magnetic field. In a preferred embodiment, instead of the wire 52 always emitting the low level signal, a control box 70 is provided in the system, preferably at the starting location 50. In one exemplary embodiment, the control box 70 has a timer 71 that provides power to an emitter producing the low level signal. In another preferred embodiment, the control box is activated by a signal from the vehicle 10. Thus, based on a signal initiated by the processor 42, the control box 70 is activated wherein AC power is supplied to the wire, thus creating the low level electromagnetic field. In operation, if a signal is not detected from the wire 52, then the processor 42 aboard the vehicle 10 prevents the vehicle 10 from activating.

At the end of the wire 52 is a ground rod 54 located beneath the ground at the trash collection location 50. In a preferred embodiment, the rod 54 is approximately twelve inches in length with a ¾ inch diameter. In a preferred embodiment, the wire 52 and rod 54 are made of cooper. The ground between the rod and the control box 70, which is sufficiently grounded, completes the electrical loop.

Though a single wire is disclosed, those skilled in the art will readily recognize that other techniques can be used to guide the vehicle 10 between the curbside location 40 and the trash collection location 50. For example, the path can be programmed into the processor wherein the vehicle 10 is provided with the exact distance to travel and a distance reading device is used to insure the vehicle 10 travel the approximate distance. In another embodiment global positioning system is utilized to guide the vehicle, especially if the present invention is used on a large plot of land, such as a farm. More than a single wire may be used. For example, a second wire may be used as a ground wire. In such a situation, the ground wire must be at a sufficient distance from the main wire 52 so as not to cancel out the magnetic field. A preferred distance is at least further away from the main wire 52 than the sensors 46 on the vehicle 10.

In a preferred embodiment, a two-motor drive 30, for moving forward and reverse, is provided, preferably with at least two speeds of operation. The wire 52 that is placed beneath the ground provides the guidance for the vehicle 10. The wire 52 will radiate a low-level signal that is detected by the sensor 46 or sensors on the vehicle 10 and thus is used to guide the vehicle 10.

In an exemplary embodiment illustrated in FIG. 5, the vehicle 10 may be housed in a shelter, such as a garage 60. To gain access outside, the vehicle 10 may exit either through a specially designated door 62, or through a main opening, such as through the front garage door 62. In either situation, a sensor-activating device 65 is provided on the vehicle 10 for opening either the garage door or the special “trap” door 62, allowing the vehicle 10 to reach its intended destination and return. In a preferred embodiment, the sensor 65 is a radio-frequency (RF) transmitter. While moving, the strobe light 18 will be activated. In another preferred embodiment, a low-sounding alarm will also activate.

The wheels 67, 68 on the vehicle 10 may be designed to either ride over a flat level surface, such as cement and/or asphalt, as well as be able to operate on an uneven surface such as gravel, grass and/or dirt. Thus, in an exemplary embodiment the wheels 67, 68 are inflatable tires. Depending on the terrain, as illustrated where the terrain is a driveway, the back wheels are inflatable tires 67 and the front wheels 68 are modular coaster-type wheels. Those skilled in the art will recognize a variety of wheels 67, 68 can be used wherein either different types of wheels or the same types of wheels can be used based on the terrain that the delivery vehicle will ride upon. The wheels, at least the forward positioned wheels will be steerable to allow the vehicle 10 to maintain its course over the wire 52.

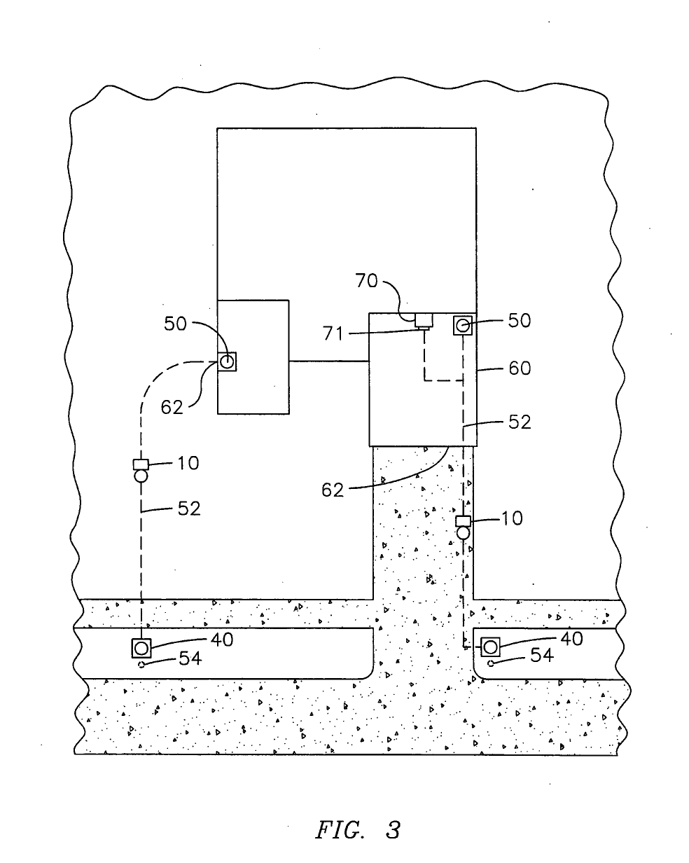

Thus, in operation as illustrated in FIG. 5, based on a user's programming of the delivery vehicle 10, the vehicle 10 will depart from a starting location 50, such as within a garage by activating a special trap door and/or the garage door and travel, using the guide wire 52 to guide it, to a curbside location 40, as also illustrated in FIG. 3. Once there, the vehicle 10 waits until the trashcan 13 and/or recycle bin 16 is removed and then returned to its resting location. If programmed to do so, the vehicle 10 will remain outside for a longer period to insure a complete charge of the battery 32. Once the time period has elapsed, the vehicle 10 will return to its trash collection location 50, as illustrated in FIG. 4. As further illustrated in FIG. 5, more than one delivery vehicle may be utilized. As illustrated, one delivery vehicle is stationed in the garage. Since a kitchen area typically generates the greatest amount of trash in a residence, a second delivery vehicle is stationed in the kitchen area.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

1. An autonomous trash delivery system, said system comprising:
a) a guide wire, having a first end and a second end, buried beneath a ground covering;
b) a power source connected to the first end of the wire providing power to the wire so that the wire emits an electromagnetic field;
(c) a delivery vehicle, for transporting at least one of a trashcan receptacle and a recycling bin receptacle from a first location to a second location, having a first sensor system for detecting the electromagnetic field emitted from the guide wire, a drive motor for propelling the delivery vehicle, a power source for supplying power to the delivery vehicle, holding locations for holding at least one of a trashcan receptacle and a recycling bin receptacle on the delivery vehicle, a processor for controlling operation of the vehicle, a user input device to access the processor, a second sensor system for determining when at least one of the trashcan receptacle or the recycling bin receptacle has been removed from the delivery vehicle to empty its contents and then returned to the delivery vehicle, and a plurality of wheels to transport the delivery vehicle over a plurality of terrain surfaces.

2. The system of claim 1 wherein the second sensor system comprises weight-measuring sensors located on the delivery vehicle to measure weight of at least the trashcan receptacle or the recycling bin receptacle.

3. The system of claim 2 wherein the weight measuring sensors and the processor are operative to determine when the delivery vehicle has traversed the wire and is parked at the second location awaiting removal of debris from at least the trashcan receptacle or the recycling bin receptacle wherein once debris is removed, the weight measuring sensors and the processor determine that the delivery vehicle is ready to return to the first location.

4. The system of claim 1 wherein the second sensor system comprises a pressure activated switching device to determine when at least one of the trashcan receptacle or the recycling bin receptacle is being removed to empty its contents and then returned to the delivery vehicle while the delivery vehicle is located at the second location.

5. The system of claim 1 wherein the delivery vehicles further comprises at least one of a visual or audible warning system to signify that the delivery vehicle is in motion.

6. The system of claim 1 wherein the power source comprises a battery connected to a solar panel array wherein the solar panel array charges the battery while the battery is at the second location when the second location is visible to sunlight.

7. The system of claim 1 wherein the power source comprises a battery connected to an electrical receptacle operatable for connection to an AC electrical outlet wherein while the delivery vehicle is at the first location the electrical receptacle is positioned on the delivery vehicle to instantly connect to the AC electrical outlet upon arrival of the delivery vehicle to the first location and the battery is charged while the delivery vehicle remains at the first location.

8. The system of claim 1 further comprises a control box located at the first location and connected to the guide wire to provide power to the guide wire that in turn creates an electromagnetic field.

9. The system of claim 8 wherein the control box further comprises a signal detection system for detecting a signal activating the control box to provide power to the guide wire and the delivery vehicle further comprises an emitter wherein the processor initiates the signal to the control box.

10. The system of claim 1 further comprises a grounding rod buried beneath the ground covering and connected to the second end of the guide wire.

11. The system of claim 9 wherein the user input device is operable to program the processor to control at least one of when to activate the control box, when to command the delivery vehicle to leave the first location, how long to delivery vehicle should remain at the second location, or days of the week said system operates.

12. The system of claim 1 further comprises an activating sensor to operate opening at least one of a garage door or an access door to allow the delivery vehicle move from the first location to the second location.

13. An automated trash delivery system, the system comprising:
a) a signal generator for generating a signal wherein a plurality of frequencies are possible for the signal;
b) a wire connected to the signal generator for carrying the signal from a first location to a second location;
c) a delivery vehicle, for transporting at least one of a trashcan receptacle and a recycling bin receptacle from the first location to the second location, comprising a first sensor system for detecting the signal carried by the guide wire, a drive motor for propelling the delivery vehicle, a power source, a frame for securing at least one of a trashcan receptacle and a recycling bin receptacle, a processor for controlling operation of the delivery vehicle, a second sensor system for determining when at least one of the trashcan receptacle or the recycling bin receptacle has been removed from the delivery vehicle to empty its contents and then returned to the delivery vehicle, and a plurality of wheels to transport the delivery vehicle over a plurality of terrain surfaces.

14. The system of claim 13 wherein the delivery vehicle further comprises a user input device for programming the processor.

15. The system of claim 13 wherein the second sensor system comprises at least one of weight-measuring sensors located on the delivery vehicle to measure weight of at least the trashcan receptacle or the recycling bin receptacle, a visual image sensor to determine when at least one of the trashcan receptacle or the recycling bin receptacle has been removed from the delivery vehicle and returned while the delivery vehicle is at the second location, or a pressure activated switching device to determine when at least one of the trashcan receptacle or the recycling bin receptacle is being removed to empty its contents and then returned to the delivery vehicle while the delivery vehicle at the second location.

16. The system of claim 13 further comprises an activating sensor to operate opening at least one of a garage door or an access door to allow the delivery vehicle move from the first location to the second location.

17. A method for autonomously delivering trash receptacles from a first location to a second location for trash removal, the method comprising:
a) activating a buried guide wire to emit a signal;
b) upon detecting the signal emitted from the guide wire, commanding a delivery vehicle holding trash receptacles to follow the emitted signal;
c) upon reaching a first end location of the buried wire emitting the signal, commanding the delivery vehicle to stop;
d) detecting when the trash receptacles have been removed from the delivery vehicle and returned to the delivery vehicle;
commanding the delivery vehicle to follow the emitted signal; and
e) upon reaching a second end location of the buried wire emitting the signal, commanding the delivery vehicle to stop.

18. The method of claim 17 wherein the step of activating a buried guide wire to emit a signal further comprises, emitting a second signal from the delivery vehicle to activate a buried guide wire to emit the signal.

19. The method of claim 17 further comprises charging a battery on the delivery vehicle when the delivery vehicle is at the first end location of the buried wire or the second end location of the buried wire.

20. The method of claim 17 further comprises emitting at least one of a visual or audible warning signal when the delivery vehicle is in motion.
